(19) United States
(12) Patent Application Publication
(10) Pub. No.: US 2012/0119858 A1
(43) Pub. Date: May 17, 2012

(54) UNIFORM MAGNETIC FIELD GENERATING EQUIPMENT AND MAGNETIC FIELD GENERATING UNIT THEREOF

(75) Inventors: Kang-Feng Lee, Taipei City (TW); Guan-Yu Lin, Changhua County (TW)

(73) Assignee: INDUSTRIAL TECHNOLOGY RESEARCH INSTITUTE, Hsinchu (TW)

(21) Appl. No.: 13/096,842

(22) Filed: Apr. 28, 2011

(30) Foreign Application Priority Data
Nov. 12, 2010 (TW) 099139070

(51) Int. Cl. H01F 7/00

(52) U.S. Cl. 335/296

(57) ABSTRACT

A magnetic field generating unit includes a first magnetic component, a second magnetic component, and a third magnetic component. The first magnetic component has a first magnetic pole, the second magnetic component surrounds the first magnetic component. The second magnetic component has a second magnetic pole facing the same direction as the first magnetic pole, and the first magnetic pole is opposite to the second magnetic pole. The third magnetic component surrounds the first magnetic component, and the third magnetic component is located between the first magnetic component and the second magnetic component. The third magnetic component has a third magnetic pole and a fourth magnetic pole, and the third magnetic pole is opposite to the fourth magnetic pole. The third magnetic pole faces the first magnetic component and the fourth magnetic pole faces the second magnetic component. The arrangement manner of the magnetic components may generate a uniform planar magnetic field.

### CROSS-REFERENCE TO RELATED APPLICATIONS

This non-provisional application claims priority under 35 U.S.C. §119(a) on Patent Application No. 099139070 filed in Taiwan, R.O.C. on Nov. 12, 2010, the entire contents of which are hereby incorporated by reference.

### BACKGROUND

1. Field

The present disclosure relates to a magnetic field generating equipment and a magnetic field generating unit thereof, and more particularly to a uniform magnetic field generating equipment capable of generating a uniform planar magnetic field and a magnetic field generating unit thereof.

2. Related Art

The application of a magnetic field is in a wide range, for example, there are needs for and arrangement of the magnetic field in the fields of opto-semiconductor equipment, motor component, super-conduction research, and magnetic levitation. For example, a magnetron sputtering technique requires that the magnetic field is distributed in parallel to a surface of a target so as to improve the usage rate of the target. The magnetic-influenced plasma-enhanced chemical vapor deposition (PECVD) technique requires a large area of magnetic field distribution parallel to the above of the substrate, so as to increase the deposition rate and film uniformity. The electron cyclotron resonator (ECR) plane coating technique requires the magnetic field uniformly distributed in parallel to the waveguide direction to have the maximum coating area.

For example, the sputtering technique widely applied in the opto-semiconductor field, the direct current and radio frequency sputtering efficiencies are low, and the magnetron sputtering uses magnetic field assisted electrons to propagate in a spiral trace to improve the collision opportunity of the electrons and the molecules of the process gas, thereby improving the plasma density and sputtering efficiency.

According to the magnetron sputtering technique, a magnetic control unit having a plurality of magnetic components is configured on the back of the target, so that the surface of the target in vacuum cavity has a magnetic field. The amount of the magnetic field orthogonal to the electric field in the cavity influences the distribution of the electron trace and further influence the area of the target bombarded with ions. Although the magnetic field may improve the sputtering efficiency of the target, when the uniformity of the magnetic field of the target surface is poor, the area of the target bombarded with ions is uneven. Thus, the usage rate of the target is lowered, thus increasing the manufacturing cost.

### SUMMARY

The present disclosure is a magnetic field generating equipment and a magnetic field generating unit thereof.

The magnetic field generating unit according to an embodiment of the present disclosure comprises a first magnetic component, a second magnetic component, and a third magnetic component. The first magnetic component has a first surface, and the first surface has a first magnetic pole. The second magnetic component is an annular body, and the second magnetic component surrounds the first magnetic component. The second magnetic component has an annular second surface, and the second surface has a second magnetic pole. The first surface and the second surface face the same side, and the first magnetic pole is opposite to the second magnetic pole. The third magnetic component is an annular body, the third magnetic component surrounds the first magnetic component, and the third magnetic component is located between the first magnetic component and the second magnetic component. The third magnetic component has a first upper surface and a first lower surface opposite to the first upper surface, and a first inner surface and a first outer surface connecting the first upper surface and the first lower surface. The first surface and the first lower surface face the same side, the first inner surface faces the first magnetic component and the first outer surface faces the second magnetic component. The first inner surface has a third magnetic pole, the first outer surface has a fourth magnetic pole, and the third magnetic pole is opposite to the fourth magnetic pole. A first virtual straight line and a second virtual straight line are perpendicular to two adjacent edges of the first magnetic component, and the first virtual straight line and the second virtual straight line extend outwards from the first magnetic component to pass through the third magnetic component and the second magnetic component, and the first virtual straight line and the second virtual straight line are both perpendicular to edges of the third magnetic component and the second magnetic component.

The uniform magnetic field generating equipment according to an embodiment of the present disclosure comprises an absorption plate, a first magnetic component, a second magnetic component, and a third magnetic component. The absorption plate has a plane, and the first magnetic component is disposed on the plane. The first magnetic component has a first surface, the first surface faces the plane, and the first surface has a first magnetic pole. The second magnetic component is an annular body and is disposed on the plane, and the second magnetic component surrounds the first magnetic component. The second magnetic component has an annular second surface, and the second surface has a second magnetic pole. The first surface and the second surface both face the plane, and the first magnetic pole is opposite to the second magnetic pole. The third magnetic component is an annular body and is disposed on the plane. The third magnetic component surrounds the first magnetic component, and the third magnetic component is located between the first magnetic component and the second magnetic component. The third magnetic component has a first upper surface and a first lower surface opposite to the first upper surface, and a first inner surface and a first outer surface connecting the first upper surface and the first lower surface. The first surface and the first lower surface both face the plane, the first inner surface faces the first magnetic component and the first outer surface faces the second magnetic component. The first inner surface has a third magnetic pole, the first outer surface has a fourth magnetic pole, and the third magnetic pole is opposite to the fourth magnetic pole and the first magnetic pole. A first virtual straight line and a second virtual straight line are perpendicular to two adjacent edges of the first magnetic component, the first virtual straight line and the second virtual straight line extend outwards from the first magnetic component to pass through the third magnetic component and the second magnetic component, and the first virtual straight line and the second virtual straight line are both perpendicular to edges of the third magnetic component and the second magnetic component.

According to the above uniform magnetic field generating equipment and magnetic field generating unit thereof, the second magnetic component and the third magnetic component are annular bodies, and both surround the first magnetic component. The third magnetic component is located between the first magnetic component and the second magnetic component. Moreover, the magnetic pole direction of the second magnetic component is opposite to the first magnetic component, and directions of two magnetic poles of the third magnetic component respectively face the first magnetic component and the second magnetic component. The arrangement manner of the magnetic components enables the magnetic field generating unit of the present disclosure to generate a uniform planar magnetic field, such that a relevant coating technique of the uniform magnetic field generating equipment of the present disclosure may be used to achieve a preferred product quality.

These and other aspects of the present disclosure will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1A is a schematic structural view of an uniform magnetic field generating equipment according to an embodiment of the present disclosure;

FIG. 1B is a plane view of the uniform magnetic field generating equipment of FIG. 1A;

FIG. 1C is a schematic structural view of a uniform magnetic field generating equipment according to another embodiment of the present disclosure;

FIG. 1D is a schematic structural view of a uniform magnetic field generating equipment according to another embodiment of the present disclosure;

FIG. 1E is a schematic structural view of a uniform magnetic field generating equipment according to another embodiment of the present disclosure;

FIG. 1F is a schematic structural view of a uniform magnetic field generating equipment according to another embodiment of the present disclosure;

FIG. 2A is a sectional view of the uniform magnetic field generating equipment of FIG. 1A according to an embodiment of the present disclosure;

FIG. 2B is a schematic view of dimensions of FIG. 2A;

FIG. 2C is an analysis chart of a magnetic field intensity of the uniform magnetic field generating equipment of FIG. 2A;

FIG. 2D is a magnetic field distribution diagram of the uniform magnetic field generating equipment of FIG. 2A;

FIG. 3A is a schematic structural view of a uniform magnetic field generating equipment according to another embodiment of the present disclosure;

FIG. 3B is a sectional view of the uniform magnetic field generating equipment of FIG. 3A;

FIG. 3C is a schematic view of dimensions of FIG. 3B;

FIG. 3D is an analysis chart of a magnetic field intensity of the uniform magnetic field generating equipment of FIG. 3B;

FIG. 3E is a magnetic field distribution diagram of the uniform magnetic field generating equipment of FIG. 3B;

FIG. 4A is a sectional view of the uniform magnetic field generating equipment according to yet another embodiment of the present disclosure;

FIG. 4B is a schematic view of dimensions of FIG. 4A;

FIG. 4C is an analysis chart of a magnetic field intensity of the uniform magnetic field generating equipment of FIG. 4A;

FIG. 4D is a magnetic field distribution diagram of the uniform magnetic field generating equipment of FIG. 4A;

FIG. 5A is an analysis chart of a magnetic field intensity of a uniform magnetic field generating equipment according to still another embodiment of the present disclosure;

FIG. 5B is a magnetic field distribution diagram of a uniform magnetic field generating equipment according to still another embodiment of the present disclosure;

FIG. 6A is an analysis chart of a magnetic field intensity of a uniform magnetic field generating equipment according to still another embodiment of the present disclosure;

FIG. 6B is a magnetic field distribution diagram of a uniform magnetic field generating equipment according to still another embodiment of the present disclosure;

FIG. 7A is another sectional view of the uniform magnetic field generating equipment according to an embodiment of the present disclosure; and

FIG. 7B is an analysis chart of a magnetic field intensity of the uniform magnetic field generating equipment according to still another embodiment of the present disclosure.

### DETAILED DESCRIPTION

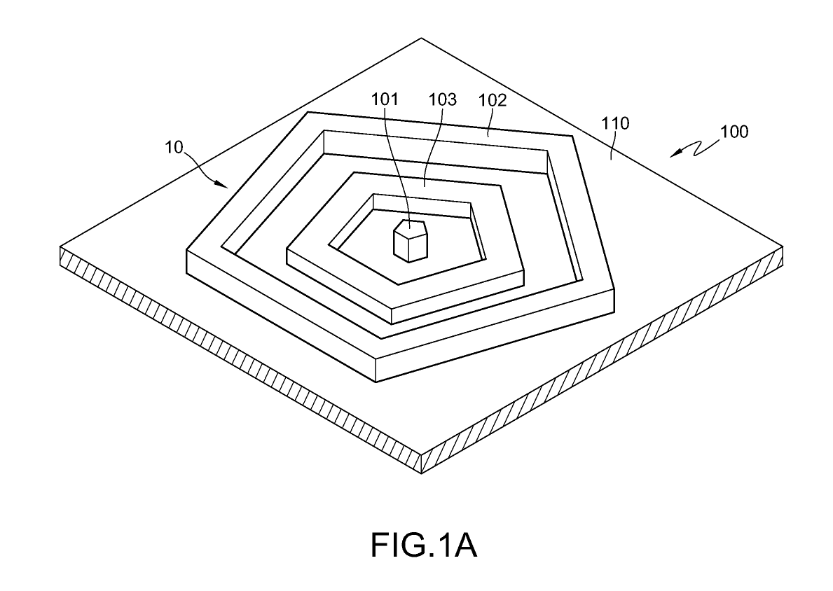

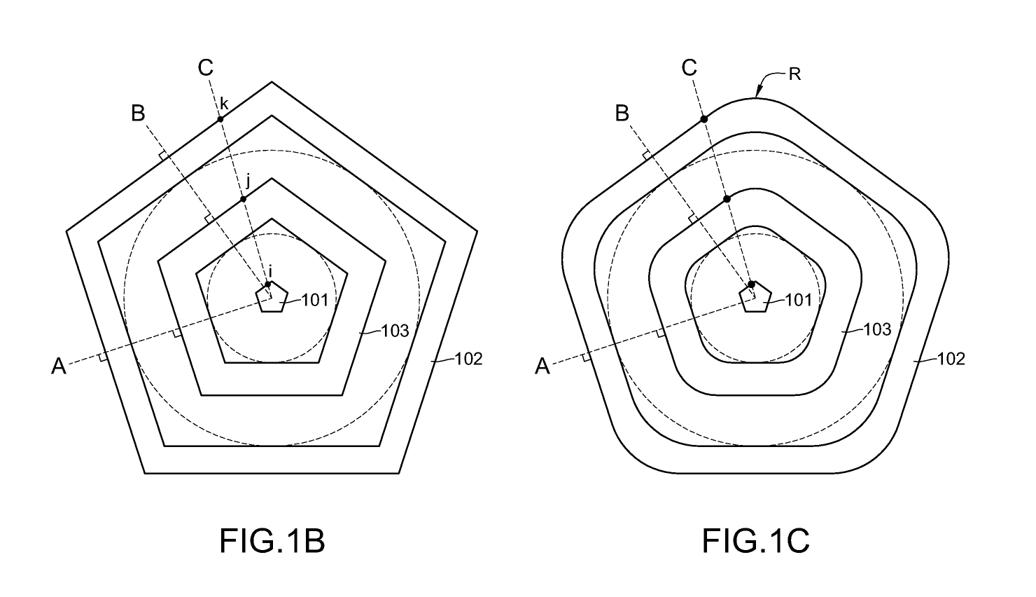

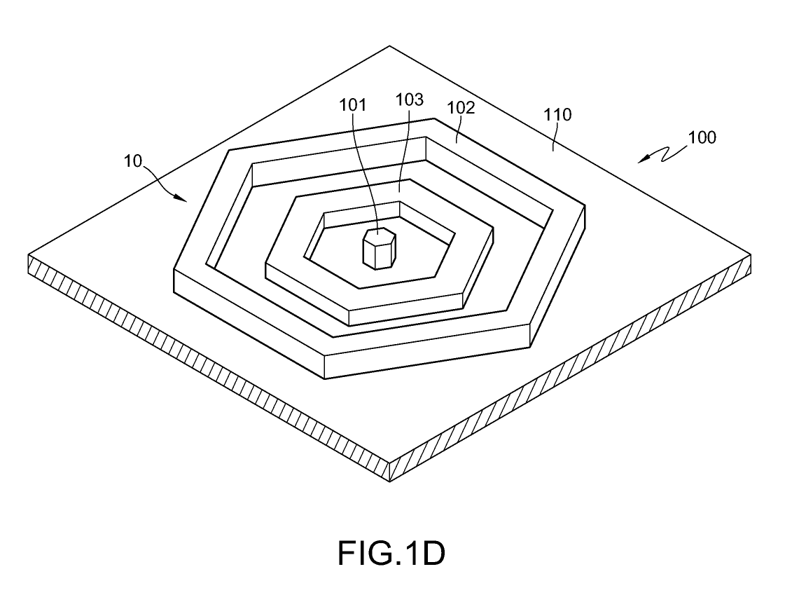

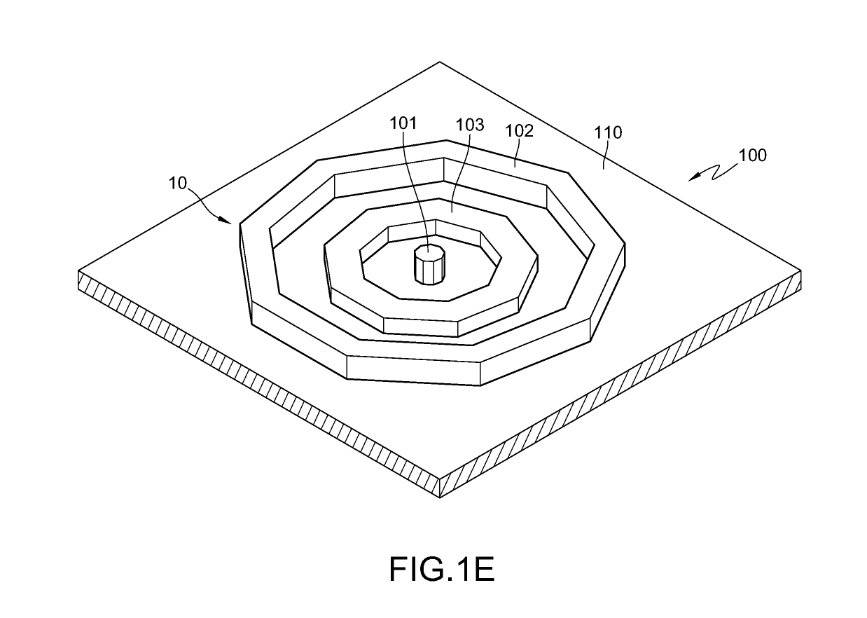

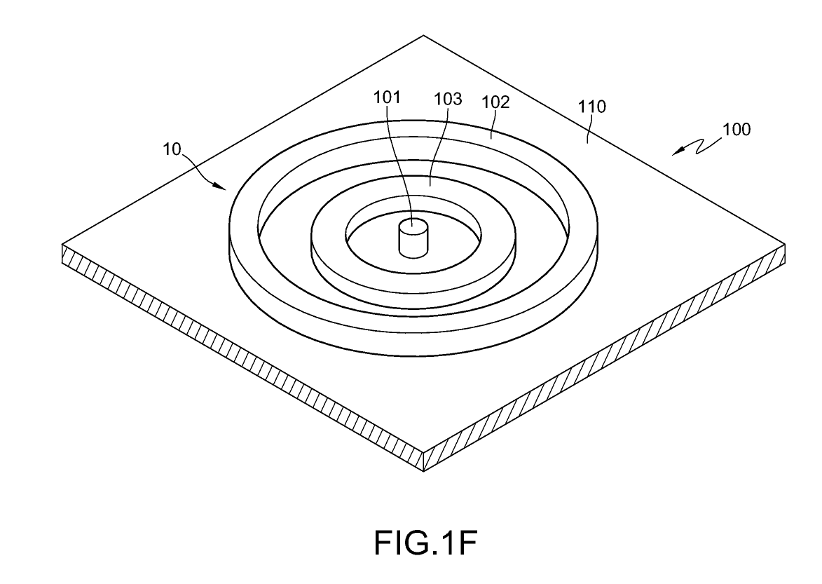

FIG. 1A is a schematic structural view of a uniform magnetic field generating equipment according to an embodiment of the present disclosure and FIG. 1B is a plane view of the uniform magnetic field generating equipment of FIG. 1A. Referring to FIG. 1A and FIG. 1B, the uniform magnetic field generating equipment of the present disclosure comprises an absorption plate 100 and a magnetic field generating unit 10. The magnetic field generating unit 10 comprises a first magnetic component 101, a second magnetic component 102, and a third magnetic component 103. The first magnetic component 101, the second magnetic component 102, and the third magnetic component 103 are disposed on a plane 110 of the absorption plate 100. The first magnetic component 101 is a column. In this embodiment, the first magnetic component 101 is, for example, a congruent pentagonal column. The second magnetic component 102 and the third magnetic component 103 are annular bodies. In this embodiment, the second magnetic component 102 and the third magnetic component 103 are, for example, congruent pentagonal annular bodies. The second magnetic component 102 and the third magnetic component 103 surround the first magnetic component 101, and the third magnetic component 103 is located between the first magnetic component 101 and the second magnetic component 102.

If a first virtual straight line A and a second virtual straight line B are respectively perpendicular to a middle point of two adjacent edges of the first magnetic component 101 (that is, perpendicular bisectors of the two adjacent edges), and the first virtual straight line A and the second virtual straight line B extend outwards to pass through the third magnetic component 103 and the second magnetic component 102. The first virtual straight line A and the second virtual straight line B are both the perpendicular bisectors of edges of the third magnetic component 103 and the second magnetic component 102.

Furthermore, when a third virtual straight line C extends from an intersection point of the first virtual straight line A and the second virtual straight line B to a quarter section point (i.e., point i) of an intersected edge of the second virtual straight line B and the first magnetic component 101, the third virtual straight line C intersects to the edges of third magnetic component 103 and the second magnetic component 102 respectively at a point j and a point k. The point j and the point k are respectively quarter section points of the edges of the third magnetic component 103 and the second magnetic component 102.

Moreover, in another embodiment of the present disclosure, corners of the congruent pentagonal column of the first magnetic component 101 and the congruent pentagonal annular bodies of the second magnetic component 102 and the third magnetic component 103 may further have a chamfer R (as shown in FIG. 1C), so as to better fit the practical implementation.

It should be noted that, in this embodiment, the first magnetic component 101 is presented to be a congruent pentagonal column, and the second magnetic component 102 and the third magnetic component 103 are presented to be congruent pentagonal annular bodies, which are not intended to limit the scope of the present disclosure. For example, as shown in FIG. 1D, the first magnetic component 101 is a congruent hexagonal column, and the second magnetic component 102 and the third magnetic component 103 are congruent hexagonal annular bodies. Or, as shown in FIG. 1E, the first magnetic component 101 is a congruent enneagonal column, and the second magnetic component 102 and the third magnetic component 103 are congruent enneagonal annular bodies. When the number of the edges of the congruent polygon approaches infinite, as shown in FIG. 1F, the first magnetic component 101 is a cylinder, the second magnetic component 102 and the third magnetic component 103 are ring bodies. The ring body of the third magnetic component 103, the ring body of the second magnetic component 102, and the cylinder of the first magnetic component 101 are coaxial.

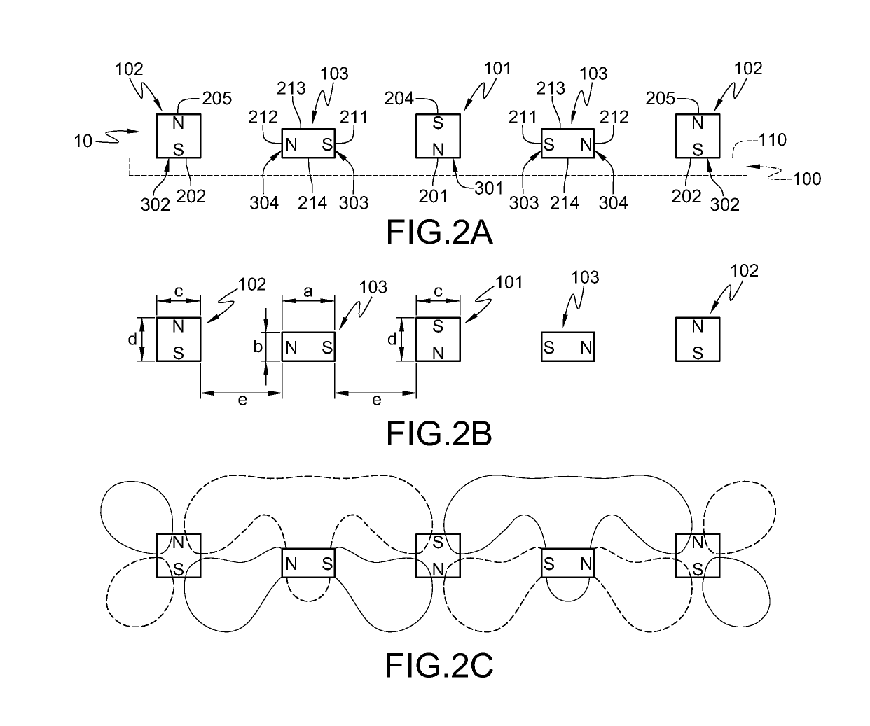

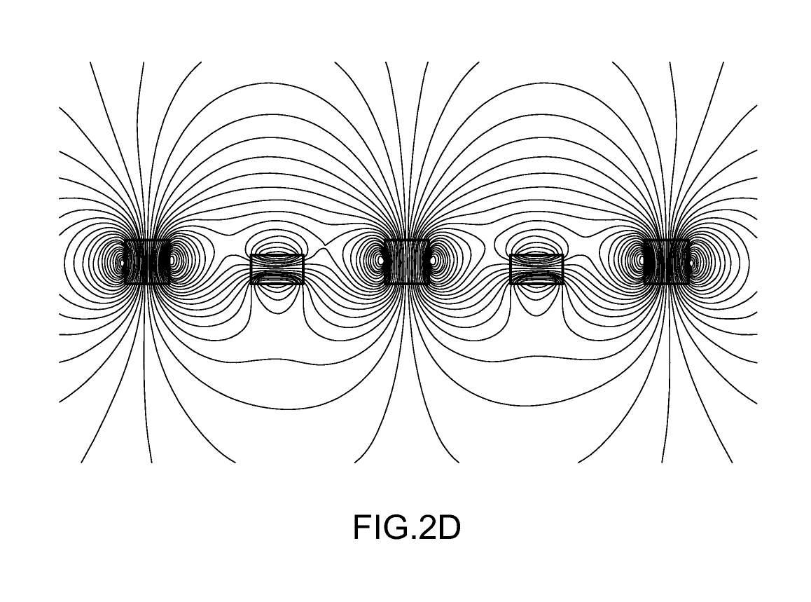

Hereinafter, the detailed structure of the uniform magnetic field generating equipment is explained, referring to FIG. 1A together with FIG. 2A and FIG. 2B. FIG. 2A is a sectional view of the uniform magnetic field generating equipment of FIG. 1A according to an embodiment of the present disclosure and FIG. 2B is a schematic view of dimensions of FIG. 2A. The sectional view of FIG. 2A is presented at a view angle along the first virtual straight line A and the second virtual straight line B.

The first magnetic component 101 of this embodiment is disposed on the plane 110 of the absorption plate 100, and the absorption plate 100 is a high magnetic conductive material having a relative permeability greater than 1, such as, Fe, Co, Ni, tungsten steel, chromium steel, Al—Ni—Co alloy, Fe—Al—Si alloy, ferrites and alloys containing rare-earth elements. The first magnetic component 101 has a first surface 201 and a fourth surface 204 opposite to the first surface 201. The first surface 201 faces the plane 110 and is disposed on the plane 110, and the first surface 201 has a first magnetic pole 301. For the simplicity of the following description, a magnetic pole of the first magnetic pole 301 is, for example, the N pole, and relatively, a magnetic pole on the fourth surface 204 of the first surface 201 is the S pole.

The second magnetic component 102 of this embodiment is disposed on the plane 110, and the second magnetic component 102 has an annular second surface 202 and an annular fifth surface 205 opposite to the annular second surface 202. The second surface 202 has a second magnetic pole 302, the first surface 201 and the second surface 202 both face the plane 110, and the second surface 202 is disposed on the plane 110. The magnetic pole of the second magnetic pole 302 is opposite to that of the first magnetic pole 301, that is to say, the magnetic pole of the second magnetic pole 302 is the S pole. Therefore, the fifth surface 205 opposite to the second surface 202 has the N pole.

In addition, the third magnetic component 103 of this embodiment is disposed on the plane 110, the third magnetic component 103 surrounds the first magnetic component 101, and the third magnetic component 103 is located between the first magnetic component 101 and the second magnetic component 102. That is to say, the third magnetic component 103 surrounds the first magnetic component 101, and the second magnetic component 102 surrounds both the third magnetic component 103 and the first magnetic component 101. The third magnetic component 103 has a first upper surface 213 and a first lower surface 214 opposite to the first upper surface 213, and a first inner surface 211 and a first outer surface 212 connecting the first upper surface 213 and the first lower surface 214. The first surface 201 and the first lower surface 214 both face the plane 110, and the first lower surface 214 is disposed on the plane 110. The first inner surface 211 faces the first magnetic component 101, and the first outer surface 212 faces the second magnetic component 102. The first inner surface 211 has a third magnetic pole 303, the first outer surface 212 has a fourth magnetic pole 304, and the third magnetic pole 303 is opposite to the fourth magnetic pole 304 and the first magnetic pole 301. It can be known from the above description that since the third magnetic pole 303 is opposite to the first magnetic pole 301 and the fourth magnetic pole 304 is the same as the first magnetic pole 301, the third magnetic pole 303 and the fourth magnetic pole 304 are respectively the S pole and the N pole.

It should be noted that the first magnetic pole 301 of this embodiment is, for example, the N pole, which are not intended to limit the scope of the present disclosure. For example, the magnetic pole of the first magnetic pole 301 may also be the S pole, and when the first magnetic pole 301 is the S pole, the second magnetic pole 302, the third magnetic pole 303 and the fourth magnetic pole 304 are correspondingly changed to be the N pole, the N pole and the S pole respectively.

Referring to FIG. 2A and FIG. 2B, the details of the uniform magnetic field generating equipment of this embodiment will be explained in the following paragraphs. The first magnetic component 101 of this embodiment has an intensity of 5000 Gauss, and has a sectional width c of the column and a height d. The value of the sectional width c of the column is 2 cm and the value of the height d is also 2 cm, as marked in FIG. 2B. The second magnetic component 102 of this embodiment has an intensity of 5000 Gauss, and has a sectional width c of the annular body and a height d. The value of the sectional width c of the annular body is 2 cm, and the value of the height d is also 2 cm, as marked in FIG. 2B. The third magnetic component 103 of this embodiment has an intensity of 1600 Gauss, and has a sectional width a of the annular body and a height b. The value of the sectional width a of the annular body is 2.4 cm, and the value of the height b is 1.3 cm, as marked in FIG. 2B. Moreover, the first magnetic component 101, the third magnetic component 103 and the second magnetic component 102 are respectively arranged with an equal interval and have a interval distance e, and the value of the interval distance e is 3.8 cm.

FIG. 2C is an analysis chart of a magnetic field intensity of the uniform magnetic field generating equipment of FIG. 2A and FIG. 2D is a magnetic path distribution diagram of the uniform magnetic field generating equipment of FIG. 2A. Referring to FIG. 2C and FIG. 2D together, the geometrical dimensions of all the magnetic components of the above embodiment are stimulated according to the practical conditions, and the magnetic field intensity and the magnetic field distribution in FIG. 2C and FIG. 2D may be obtained. FIG. 2C is a Gauss distribution diagram of a magnetic field intensity 300, in which the difference between the solid line and dashed line is only the difference of the magnetic path directions. As shown in FIG. 2C, the uniform magnetic field generating equipment of this embodiment may be embodied to generate the uniform planar magnetic field, and the planar magnetic field is generated on the side of the magnetic component opposite to the absorption plate 100, that is to say, the planar magnetic field is generated on the side to which the fourth surface 204, the first upper surface 213 and the fifth surface 205 are facing.

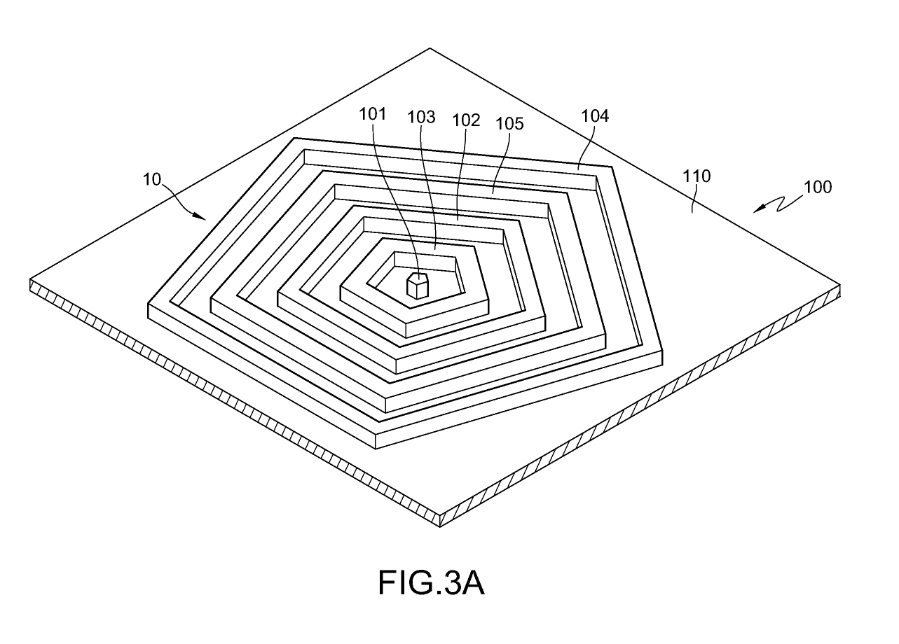

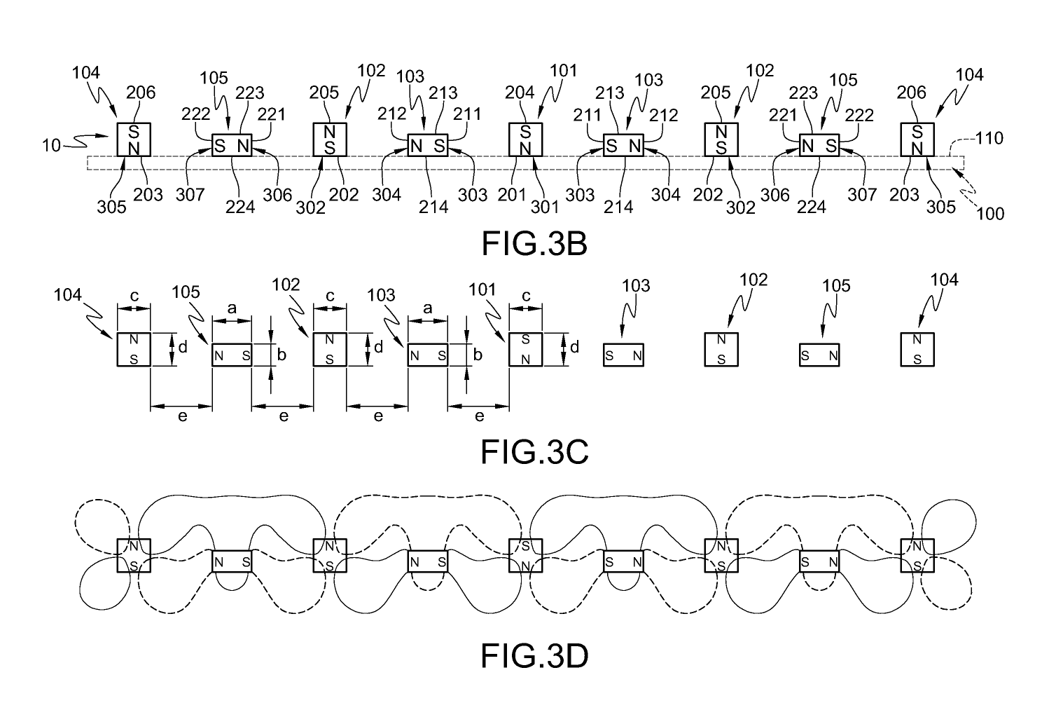

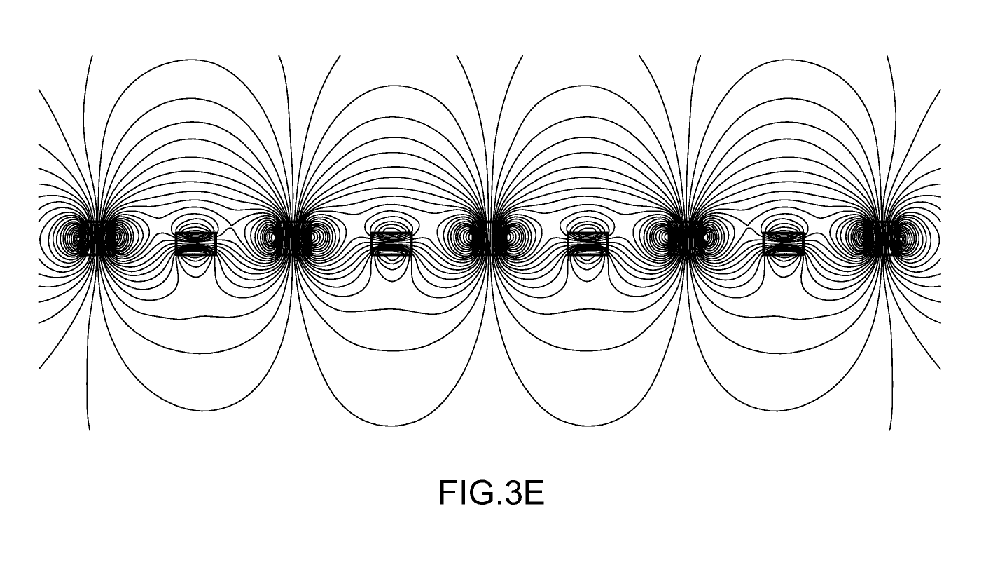

In the above embodiments of the present disclosure, three magnetic components surrounding each other are taken as the example, but the quantity of the magnetic component is not intended to limit the scope of the present disclosure. For example, the uniform magnetic field generating equipment of the present disclosure may also adopt five magnetic components. Referring to FIG. 3A to FIG. 3C, FIG. 3A is a schematic structural view of a uniform magnetic field generating equipment according to another embodiment of the present disclosure, FIG. 3B is a sectional view of the uniform magnetic field generating equipment of FIG. 3A, and FIG. 3C is a schematic view of dimensions of FIG. 3B. The structures of this embodiment and the embodiment of FIG. 1A are the same in essentials except that two more magnetic components are disposed in this embodiment, and the geometrical arrangement is the same as that of FIG. 1A, so only the difference will be explained in the following paragraphs.

The uniform magnetic field generating equipment of the present disclosure may further comprise a fourth magnetic component 104 and a fifth magnetic component 105. The fourth magnetic component 104 is disposed on the plane 110 of the absorption plate 100. The fourth magnetic component 104 surrounds the second magnetic component 102, that is to say, the fourth magnetic component 104 may surrounds the first magnetic component 101 and the third magnetic component 103 at the same time. The fourth magnetic component 104 has an annular third surface 203 and an annular sixth surface 206 opposite to the annular third surface 203, and the third surface 203 has a fifth magnetic pole 305. The third surface 203 and the second surface 202 both face the plane 110, and the third surface 203 is disposed on the plane 110. The fifth magnetic pole 305 is opposite to the second magnetic pole 302, that is to say, the magnetic pole of the fifth magnetic pole 305 is N pole, so the magnetic pole on the sixth surface 206 opposite to the third surface 203 is the S pole.

In addition, the fifth magnetic component 105 of this embodiment is disposed on the plane 110. The fifth magnetic component 105 surrounds the second magnetic component 102, and the fifth magnetic component 105 is located between the second magnetic component 102 and the fourth magnetic component 104. That is to say, the fifth magnetic component 105 surrounds the first magnetic component 101, the second magnetic component 102 and the third magnetic component 103 at the same time, and the fourth magnetic component 104 surrounds the first magnetic component 101, the second magnetic component 102, the third magnetic component 103 and the fifth magnetic component 105 at the same time. The fifth magnetic component 105 has a second upper surface 223 and a second lower surface 224 opposite to the second upper surface 223, and a second inner surface 221 and a second outer surface 222 connecting the second upper surface 223 and the second lower surface 224. The second surface 202 and the second lower surface 224 both face the plane 110, and the second lower surface 224 is disposed on the plane 110. The second inner surface 221 faces the second magnetic component 102, and the second outer surface 222 faces the fourth magnetic component 104. The second inner surface 221 has a sixth magnetic pole 306, the second outer surface 222 has a seventh magnetic pole 307, and the sixth magnetic pole 306 is opposite to the seventh magnetic pole 307 and the second magnetic pole 302. It is known from the above that since the sixth magnetic pole 306 is opposite to the second magnetic pole 302, the seventh magnetic pole 307 is the same as the second magnetic pole 302, the sixth magnetic pole 306 and the seventh magnetic pole 307 are respectively the N pole and the S pole.

Referring to FIG. 3B and FIG. 3C, the details of the geometrical dimensions of all the magnetic components of the uniform magnetic field generating equipment according to this embodiment will be explained in the following paragraphs. The geometrical dimensions of the first magnetic component 101, the second magnetic component 102 and the third magnetic component 103 in this embodiment is the same as that of FIG. 2B, so only the geometrical dimensions of the fourth magnetic component 104 and the fifth magnetic component 105 are explained in details. The fourth magnetic component 104 of this embodiment has an intensity of 5000 Gauss and has a sectional width c of the annular body and a height d. The value of the sectional width c of the annular body is 2 cm, and the value of the height d is also 2 cm, as marked in FIG. 3C. Therefore, from the sectional view of FIG. 3C, the cross-section of the fourth magnetic component 104 is the same as that of the second magnetic component 102. The fifth magnetic component 105 of this embodiment has an intensity of 1600 Gauss, and has a sectional width a of the annular body and a height b. The sectional width a of the annular body is 2.4 cm, and the height b is 1.3 cm, as marked in FIG. 2B. Therefore, from the sectional view of FIG. 3C, the cross-section of the fifth magnetic component 105 is the same as that of the third magnetic component 103. Moreover, the first magnetic component 101, the second magnetic component 102, the third magnetic component 103, the fourth magnetic component 104 and the fifth magnetic component 105 are respectively arranged with an equal interval and have an interval distance e, and the value of the interval distance e is 3.8 cm.

Referring to FIG. 3D and FIG. 3E together, FIG. 3D is an analysis chart of a magnetic field intensity of the uniform magnetic field generating equipment of FIG. 3A and FIG. 3E is a magnetic field distribution diagram of the uniform magnetic field generating equipment of FIG. 3A. The geometrical dimensions of all the magnetic components of the above embodiment are stimulated according to the practical conditions, and the magnetic field intensity and the magnetic field distribution in FIG. 3D and FIG. 3E may be obtained. FIG. 3D is a Gauss distribution diagram of a magnetic field intensity 300, in which the difference between the solid line and dashed line is only the difference of the magnetic path directions. As shown in FIG. 3D, the uniform magnetic field generating equipment of this embodiment may be embodied to generate the uniform planar magnetic field, and the planar magnetic field is generated on the side of the magnetic component opposite to the absorption plate 100, that is to say, the planar magnetic field is generated on the side to which the fourth surface 204, the first upper surface 213, the fifth surface 205, the second upper surface 223 and the sixth surface 206 are facing.

In the above embodiments of the present disclosure, five magnetic components surrounding each other are taken as the example, but the quantity of the magnetic component is not intended to limit the scope of the present disclosure. Further, as long as the arrangement of the magnetic components follows the rule of the embodiment of FIG. 2A, the number of the magnetic component may be further extended so as to generate the planar magnetic field with a larger area.

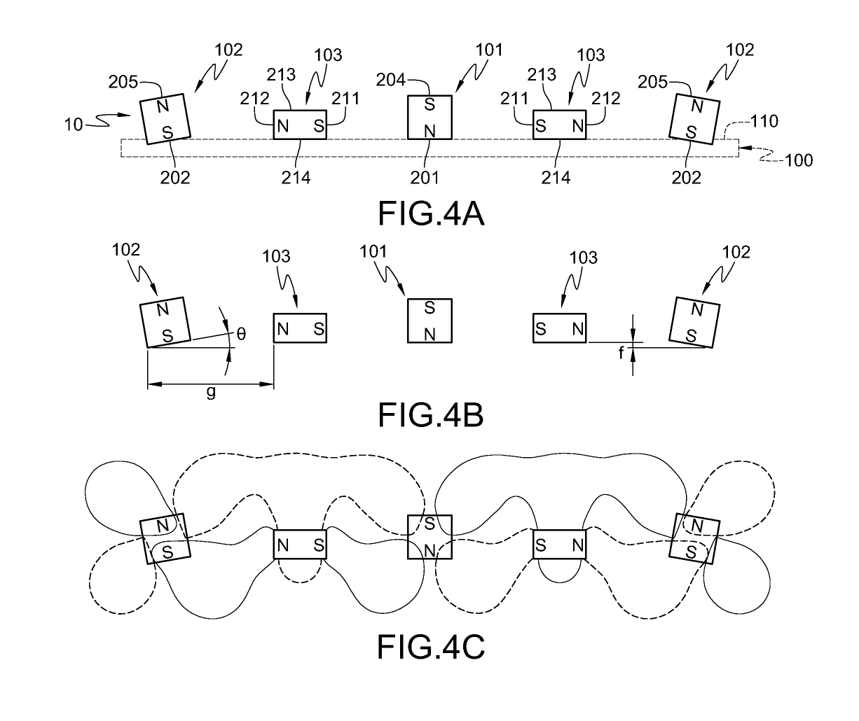

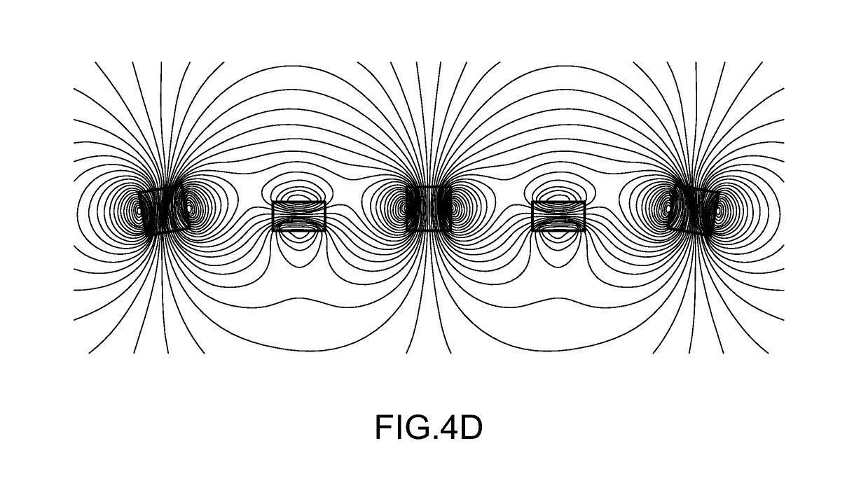

Referring to FIG. 4A and FIG. 4B, FIG. 4A is a sectional view of the uniform magnetic field generating equipment according to yet another embodiment of the present disclosure, and FIG. 4B is a schematic view of dimensions of FIG. 4A. This embodiment is substantially the same as that of FIG. 2A and FIG. 2B, so only the difference will be explained herein. Regarding the uniform magnetic field generating equipment of this embodiment, the intensity of the second magnetic component 102 is 5400 Gauss, and an angle θ is included between the second surface 202 of the second magnetic component 102 and the first surface 201 of the first magnetic component 101, the angle θ may be, but not limited to, 10°. In this embodiment, the second magnetic component 102 and the third magnetic component 103 have a height difference f, and the height difference f is 0.1 cm.

Referring to together FIG. 4C and FIG. 4D, FIG. 4C is an analysis chart of a magnetic field intensity of the uniform magnetic field generating equipment of FIG. 4A, and FIG. 4D is a magnetic field distribution diagram of the uniform magnetic field generating equipment of FIG. 4A. The geometrical dimensions of arrangement of all the magnetic components of the above embodiment are stimulated according to the practical conditions, and the magnetic field intensity and the magnetic field distribution in FIG. 4C and FIG. 4D may be obtained. FIG. 4C is a Gauss distribution diagram of a magnetic field intensity 300, in which the difference between the solid line and dashed line is only the difference of the magnetic path directions. As shown in FIG. 4C, the uniform magnetic field generating equipment of this embodiment may be embodied to generate the uniform planar magnetic field, and the planar magnetic field is generated on the side of the magnetic component opposite to the absorption plate 100, that is to say, the planar magnetic field is generated on the side to which the fourth surface 204, the first upper surface 213 and the fifth surface 205 are facing. In other words, even if the second surface 202 of the second magnetic component 102 and the first surface 201 of the first magnetic component 101 are co-planar and have an included angle therebetween, by properly adjusting the positions and the magnetic pole intensity of the magnetic components, the uniform planar magnetic field can still be generated.

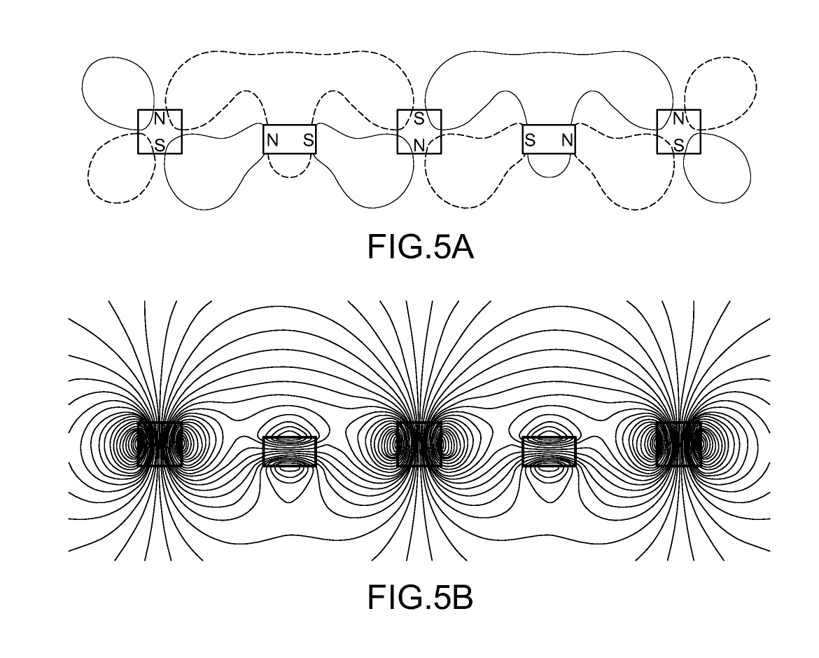

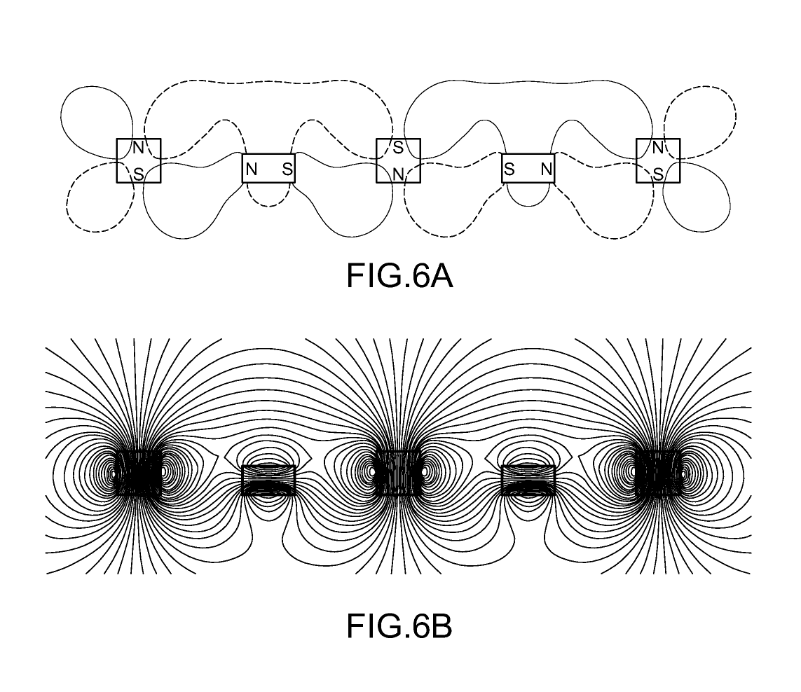

Referring to FIG. 5A, FIG. 5B, FIG. 6A and FIG. 6B, FIG. 5A is an analysis chart of a magnetic field intensity of the uniform magnetic field generating equipment according to still another embodiment of the present disclosure, FIG. 5B is a magnetic field distribution diagram of the uniform magnetic field generating equipment according to still another embodiment of the present disclosure, FIG. 6A is an analysis chart of a magnetic field intensity of the uniform magnetic field generating equipment according to still another embodiment of the present disclosure, and FIG. 6B is a magnetic field distribution diagram of the uniform magnetic field generating equipment according to still another embodiment of the present disclosure.

In the embodiments of FIG. 5A and FIG. 5B, the magnetic field intensity and the magnetic field distribution are stimulated by scaling down in a proportion of 0.25 to the geometrical dimensions of the uniform magnetic field generating equipment in FIG. 2A. In the embodiments of FIG. 6A and FIG. 6B, the magnetic field intensity and the magnetic field distribution are stimulated by amplifying in a proportion of 2 to the geometrical dimensions of the uniform magnetic field generating equipment in FIG. 2A. From FIG. 5A and FIG. 6A, it is known that the uniform magnetic field generating equipment after the proportional scaling down/amplifying may still generate a uniform planar magnetic field. That is to say, the uniform magnetic field generating equipment of the present disclosure always possesses the characteristic of generating the uniform planar magnetic field without being affected or influenced by the proportional amplifying or scaling down of the geometrical dimensions.

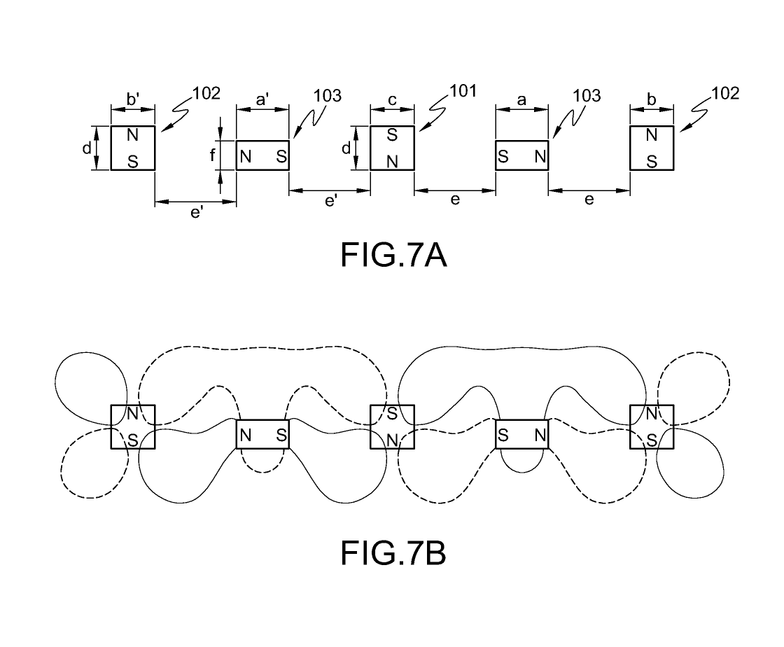

Referring to FIG. 7A and FIG. 7B, FIG. 7A is another sectional view of the uniform magnetic field generating equipment according to an embodiment of the present disclosure and FIG. 7B is an analysis chart of a magnetic field intensity of the uniform magnetic field generating equipment according to still another embodiment of the present disclosure. The sectional view of FIG. 7A is presented along the first virtual straight line A and the third virtual straight line C (as shown in FIG. 1B).

Therefore, the sectional geometrical shape of FIG. 7A and the sectional geometrical shape of FIG. 2B are somewhat different. The relevant values are expressed as

a=2.4 cm; a′=2.55 cm; b=2 cm; b′=2.13 cm; c=2.06 cm; d=2 cm; e=3.8 cm; e′=4.05 cm; f=1.3 cm. By analysis with the magnetic field intensity stimulated based on this cross-section, the magnetic field intensity indicated by the dashed line is reduced to 285 Gauss. The analysis result shows that even if the proportions of the cross-section are different to the design of FIG. 2B, the variation of the magnetic field intensity caused by the non-proportional geometrical difference is only 5% (300 Gauss and 285 Gauss), which is similar to the range (±10%) of fabricating errors of the magnetic component in implementation. Therefore, the uniform magnetic field generating equipment of this embodiment may generate a quite uniform magnetic field.

According to the above uniform magnetic field generating equipment and a magnetic field generating unit thereof, the second magnetic component and the third magnetic component are annular bodies and both surround the first magnetic component, and the third magnetic component is located between the first magnetic component and the second magnetic component. Moreover, the magnetic pole direction of the second magnetic component is opposite to that of the first magnetic component, and the directions of two magnetic poles of the third magnetic component respectively face the first magnetic component and the second magnetic component. This arrangement manner of the magnetic components enables the magnetic field generating unit of the present disclosure to generate the uniform planar magnetic field, and further the related coating technique of the uniform magnetic field generating equipment of the present disclosure may be applied to achieve a better production quality. In practical applications, the user may further expand the number of the magnetic component, so that the uniform magnetic field generating equipment may achieve the uniform planar magnetic field having a large area, thereby facilitating the improvement of the coating technique.

What is claimed is:

1. A magnetic field generating unit, comprising:
a first magnetic component, having a first surface with a first magnetic pole;
a second magnetic component, being an annular body, and surrounding the first magnetic component, wherein the second magnetic component has an annular second surface, the second surface has a second magnetic pole, the first surface and the second surface both face the same side, and the first magnetic pole is opposite to the second magnetic pole; and
a third magnetic component, being an annular body, surrounding the first magnetic component, and located between the first magnetic component and the second magnetic component, wherein the third magnetic component has a first upper surface and a first lower surface opposite to the first upper surface, and a first inner surface and a first outer surface connecting the first upper surface and the first lower surface, the first surface and the first lower surface both face the same side, the first inner surface faces the first magnetic component, the first outer surface faces the second magnetic component, the first inner surface has a third magnetic pole, the first outer surface has a fourth magnetic pole, and the third magnetic pole is opposite to the fourth magnetic pole;
wherein a first virtual straight line and a second virtual straight line are perpendicular to two adjacent edges of the first magnetic component, the first virtual straight line and the second virtual straight line extend outwards from the first magnetic component to pass through the third magnetic component and the second magnetic component, and the first virtual straight line and the second virtual straight line are both perpendicular to edges of the third magnetic component and the second magnetic component intersected thereto.

2. The magnetic field generating unit according to claim 1, wherein a profile of the first magnetic component is a column, and profiles of the second magnetic component and the third magnetic component are congruent polygonal annular bodies;
wherein the first virtual straight line and the second virtual straight line are respectively perpendicular bisectors of two adjacent edges of the first magnetic component, a third virtual straight line extends from an intersection point of the first virtual straight line and the second virtual straight line to a quarter section point of an intersected edge of the first magnetic component intersected with the second virtual straight line, and is also respectively intersected at quarter section points of edges of the third magnetic component and the second magnetic component.

3. The magnetic field generating unit according to claim 1, further comprising:
a fourth magnetic component, being an annular body, and surrounding the second magnetic component, wherein the fourth magnetic component has an annular third surface, the third surface has a fifth magnetic pole, the third surface and the second surface both face the same side, and the fifth magnetic pole is opposite to the second magnetic pole; and
a fifth magnetic component, being an annular body, surrounding the second magnetic component, and located between the second magnetic component and the fourth magnetic component, wherein the fifth magnetic component has a second upper surface and a second lower surface opposite to the second upper surface, and a second inner surface and a second outer surface connecting the first upper surface and the second lower surface, the second surface and the second lower surface both face the same side, the second inner surface faces the second magnetic component, the second outer surface faces the fourth magnetic component, the second inner surface has a sixth magnetic pole, the first outer surface has a seventh magnetic pole, and the sixth magnetic pole is opposite to the seventh magnetic pole;
wherein the first virtual straight line and the second virtual straight line extend outwards from the first magnetic component to pass through the fifth magnetic component and the fourth magnetic component, and the first virtual straight line and the second virtual straight line are both perpendicular to edge of the fifth magnetic component and the fourth magnetic component intersected thereto.

4. The magnetic field generating unit according to claim 3, wherein a profile of the first magnetic component is a column, and profiles of the second magnetic component, the third magnetic component, the fourth magnetic component, and the fifth magnetic component are congruent polygonal annular bodies;
wherein the first virtual straight line and the second virtual straight line are respectively perpendicular bisectors of two adjacent edges of the first magnetic component, a third virtual straight line extends from an intersection point of the first virtual straight line and the second virtual straight line to a quarter section point of an intersected edge of the first magnetic component intersected with the second virtual straight line, and is also respectively intersected at quarter section points of edges of the third magnetic component, the second magnetic component, the fifth magnetic component, and the fourth magnetic component.

5. The magnetic field generating unit according to claim 1, wherein an angle is included between the second surface of the second magnetic component and the first surface of the first magnetic component.

6. A uniform magnetic field generating equipment, comprising:
an absorption plate, having a plane;
a first magnetic component, disposed on the plane, wherein the first magnetic component has a first surface, the first surface faces the plane, and the first surface has a first magnetic pole;
a second magnetic component, being an annular body, disposed on the plane, and surrounding the first magnetic component, wherein the second magnetic component has an annular second surface, the second surface has a second magnetic pole, the first surface and the second surface both face the plane, and the first magnetic pole is opposite to the second magnetic pole; and
a third magnetic component, being an annular body, disposed on the plane, surrounding the first magnetic component, and located between the first magnetic component and the second magnetic component, wherein the third magnetic component has a first upper surface and a first lower surface opposite to the first upper surface, and a first inner surface and a first outer surface connecting the first upper surface and the first lower surface, the first surface and the first lower surface both face the plane, the first inner surface faces the first magnetic component, the first outer surface faces the second magnetic component, the first inner surface has a third magnetic pole, the first outer surface has a fourth magnetic pole, and the third magnetic pole is opposite to the fourth magnetic pole and the first magnetic pole;
wherein a first virtual straight line and a second virtual straight line are perpendicular to two adjacent edges of the first magnetic component, the first virtual straight line and the second virtual straight line extend outwards from the first magnetic component to pass through the third magnetic component and the second magnetic component, and the first virtual straight line and the second virtual straight line are both perpendicular to edges of the third magnetic component and the second magnetic component intersected thereto.

7. The uniform magnetic field generating equipment according to claim 6, wherein a profile of the first magnetic component is a column, and profiles of the second magnetic component and the third magnetic component are congruent polygonal annular bodies;
wherein the first virtual straight line and the second virtual straight line are respectively perpendicular bisectors of two adjacent edges of the first magnetic component, a third virtual straight line extends from an intersection point of the first virtual straight line and the second virtual straight line to a quarter section point of an intersected edge of the first magnetic component intersected with the second virtual straight line, and is also respectively intersected at quarter section points of edges of the third magnetic component and the second magnetic component.

8. The uniform magnetic field generating equipment according to claim 6, further comprising:
a fourth magnetic component, being an annular body, disposed on the plane, and surrounding the second magnetic component, wherein the fourth magnetic component has an annular third surface, the third surface has a fifth magnetic pole, the third surface and the second surface both face the plane, and the fifth magnetic pole is opposite to the second magnetic pole; and
a fifth magnetic component, being an annular body, disposed on the plane, surrounding the second magnetic component, and located between the second magnetic component and the fourth magnetic component, wherein the fifth magnetic component has a second upper surface and a second lower surface opposite to the second upper surface, and a second inner surface and a second outer surface connecting the second upper surface and the second lower surface, the second surface and the second lower surface both face the plane, the second inner surface faces the second magnetic component, the second outer surface faces the fourth magnetic component, the second inner surface has a sixth magnetic pole, the first outer surface has a seventh magnetic pole, and the sixth magnetic pole is opposite to the seventh magnetic pole and the second magnetic pole;
wherein the first virtual straight line and the second virtual straight line extend outwards from the first magnetic component to pass through the fifth magnetic component and the fourth magnetic component, and the first virtual straight line and the second virtual straight line are both perpendicular to edges of the fifth magnetic component and the fourth magnetic component intersected thereto.

9. The uniform magnetic field generating equipment according to claim 8, wherein a profile of the first magnetic component is a column, and profiles of the second magnetic component, the third magnetic component, the fourth magnetic component, and the fifth magnetic component are congruent polygonal annular bodies;
wherein the first virtual straight line and the second virtual straight line are respectively perpendicular bisectors of two adjacent edges of the first magnetic component, a third virtual straight line extends from an intersection point of the first virtual straight line and the second virtual straight line to a quarter section point of an intersected edge of the first magnetic component intersected with the second virtual straight line, and is also respectively intersected at quarter section points of edges of the third magnetic component, the second magnetic component, the fifth magnetic component, and the fourth magnetic component.

10. The uniform magnetic field generating equipment according to claim 6, wherein an angle is included between the second surface of the second magnetic component and the first surface of the first magnetic component.
